(19) United States
(12) Patent Application Publication
(10) Pub. No.: US 2023/0382312 A1
(43) Pub. Date: Nov. 30, 2023

(54) MOTOR VEHICLE INNER TRIM PANEL

(71) Applicant: TREVES AUDIO, Reims (FR)

(72) Inventors: Eric Brillon, Paris (FR); Arnaud Duval, Paris (FR); Jean-Philippe Thome, Saint-Genes-Champelle (FR)

(21) Appl. No.: 18/027,603

(22) PCT Filed: Sep. 21, 2021
(86) PCT No.: PCT/EP2021/075950

§ 371 Date: Mar. 21, 2023

(30) Foreign Application Priority Data
Sep. 24, 2020 (FR) FR2009728

(51) Int. Cl. B60R 11/02; B60R 13/02

(52) U.S. Cl. CPC B60R 11/0223; B60R 13/02; B60R 2013/0287; B60R 2011/0003

(57) ABSTRACT

A motor vehicle inner trim panel having a molded core and: a base which is overmolded by the core in an attachment zone, the base being provided with forked ties which project from the core; a ring which is provided with receiving means interlocking with the forked ties, the ring further being provided with two electric connectors, the central opening of the ring being provided with a thread; a transducer which is provided with a generally cylindrical attachment portion (12) which is threaded and screwed into the opening, the free end of the attachment portion abutting in the zone so as to ensure gripping contact between the forked ties and the receiving means, the transducer further being provided with two reciprocal electric connectors on which each of the connectors abut, respectively.

The invention relates to a motor vehicle inner trim panel provided with an electrodynamic or magnetostrictive transducer.

It is known to make such a panel allowing propagating within a motor vehicle passenger compartment the signal derived from an amplifier, the use of a transducer instead of a loudspeaker allowing in particular a gain in weight and space.

Various problems appear when such an arrangement is implemented: simplifying mounting, optimising the transmission of the signal from the amplifier to the panel (via the transducer), ensuring the reliability of the electrical contacts, suppressing the risk of parasitic vibrations.

The invention aims to provide a panel allowing reconciling these various requirements.

To this end, the invention provides a motor vehicle inner trim panel, said panel comprising a moulded core, said panel further comprising:
a base overmoulded by said core in an fixing zone, said base being provided with harpoon projecting from said core,
a ring provided with receiving means interlocking with said harpoon, so as to associate said ring with said base, said ring being further provided with two electric connectors intended to be connected to the outputs of an amplifier, the central opening of said ring being provided with a thread,
an electrodynamic or magnetostrictive transducer which is provided with an attachment portion in the general form of a threaded cylinder screwed into said opening, the free end of said attachment portion bearing in said zone so as to create a separation force between said ring and said base ensuring gripping contact between said harpoon and said receiving means, said transducer being further provided with two reciprocal electric connectors on which each of said connectors bears respectively.

With the proposed arrangement:
mounting of the transducer on the panel is very simple since it comes down to interlocking the ring and screwing the transducer onto the latter, the rotational stroke can be defined as a small angular sector in order to further simplify mounting,
embedding the base in the core allows ensuring a continuous surface contact, and not punctual (as would be the case for example in fastening the base by screws creating an air gap between said base and said core), between said base and the panel, and thus optimising the transmission of the signal of the amplifier to the panel via the transducer,
optimum electrical contacts result from the screwing operation which allows setting the contactors and reciprocal contactors in reciprocal bearing,
the free end of the attachment portion bearing in the fixing zone allows creating a separation force between the ring and the base and thus ensuring tight contact between said harpoon and said receiving means, which allows avoiding clearances between the base and the ring and between the ring and the transducer, and therefore to avoiding parasitic vibrations.

Other particularities and advantages of the invention will appear in the following description, made with reference to the appended figures, wherein:

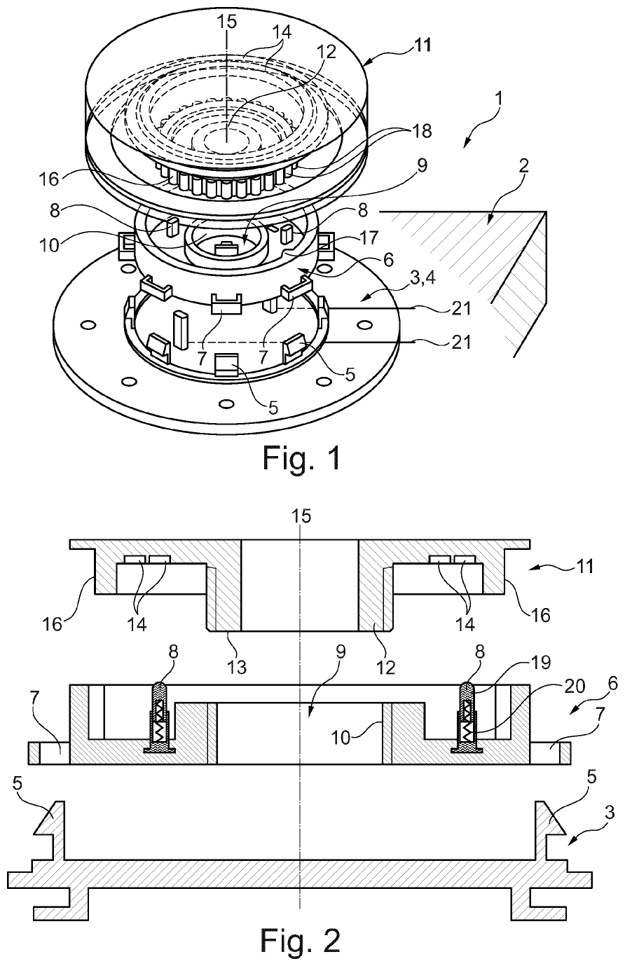

FIG. 1 is a schematic exploded partial perspective semi-transparent view of a panel according to one embodiment,

FIG. 2 is a schematic exploded partial sectional view of the panel of FIG. 1,

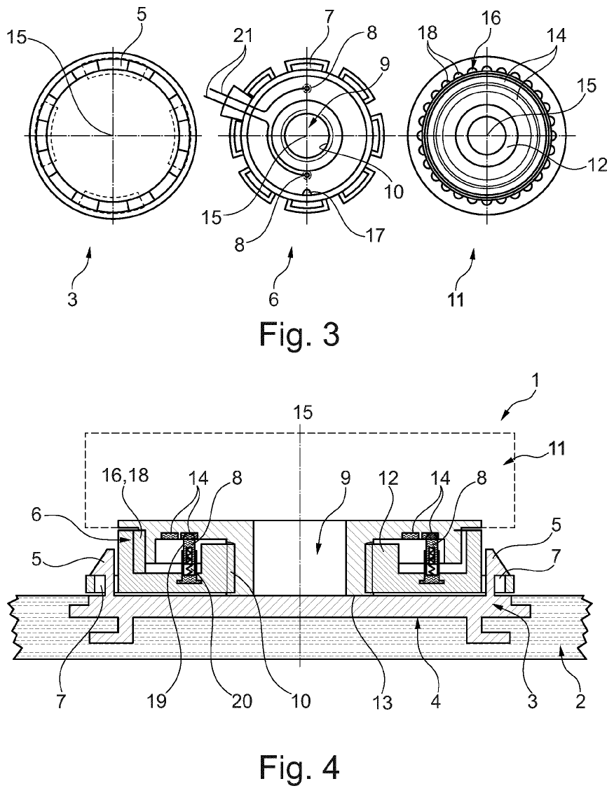

FIG. 3 is a schematic front view of respectively the base, the ring and the transducer of the panel of FIG. 1,

FIG. 4 is a schematic non-exploded partial sectional view of the panel of FIG. 1,

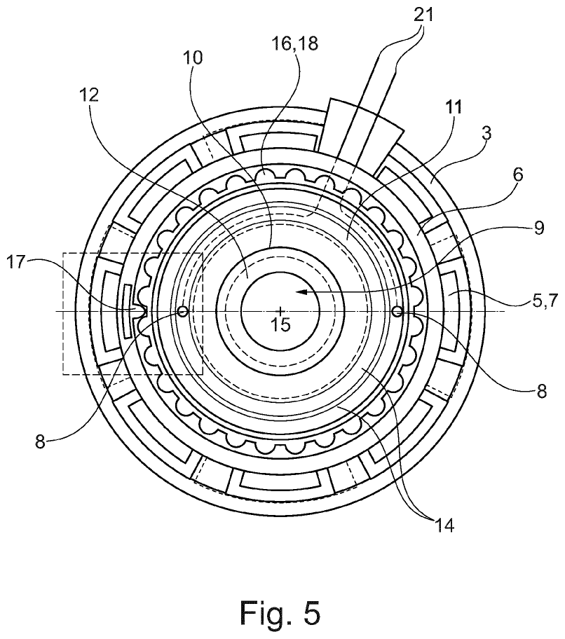

FIG. 5 is a schematic front view corresponding to FIG. 4.

Referring to the figures, a motor vehicle inner trim panel 1 is described—for example a cover shelf of a luggage compartment, a storage tray cover or a seatback rear shell —, said panel comprising a moulded core 2, said panel further comprising:
a base 3—in particular made of a moulded plastic material—overmoulded by said core in an attachment zone 4, said base being provided with harpoon 5 projecting from said core,
a ring 6—in particular made of a moulded plastic material—provided with means—herein disposed at the periphery of said ring—for receiving 7 in an interlocked fashion said harpoon said means being herein disposed at the periphery of said ring —, so as to associate said ring with said base, said ring being further provided with two electric connectors 8 intended to be connected to the outputs of an amplifier, the central opening 9 of said ring being provided with a thread 10,
an electrodynamic or magnetostrictive transducer 11 which is provided with an attachment portion 12—in particular made of a moulded plastic material—in the general form of a threaded cylinder screwed into said opening, the free end 13 of said attachment portion bearing in said zone—on said base in the represented embodiment, or on the core in the non-represented embodiment when said base is embedded in said core—so as to create a separation force between said ring and said base ensuring tight contact between said harpoon and said receiving means, said transducer being further provided with two reciprocal electric connectors 14 on which each of said connectors bears respectively.

In particular, the core 2 is based on rigid or semi-rigid polyurethane foam, i.e. a foam that is not elastically compressible (unlike the foams used for example to make seat cushions), said foam not being able to recover its initial geometry after having been compressed by 50% of its initial thickness.

For example, the core 2 is in the form of:
a block of polyurethane foam reinforced with glass fibres,
or a “honeycomb” plate, in particular made of cardboard, the two sides of which are each covered with a sheet of glass fibres embedded in rigid polyurethane foam.

According to the represented embodiment, the free end 13 is inscribed in a plane bearing in the fixing zone 4 lying in the same plane, so as to ensure surface contact between the two, allowing optimising the transmission of the signal derived from the amplifier.

According to the represented embodiment, the connectors 8—respectively or the reciprocal connectors 14 in the non-represented variant—are in the form of terminals and the reciprocal connectors 14—respectively or the connectors 8 in the non-represented variant—in the form of concentric tracks, which allows guaranteeing electrical contact between the two regardless of the angular stroke performed to complete screwing of the transducer 11.

According to the represented embodiment, the terminals are in the form of studs 19 mounted on a spring 20, so as to ensure electrical contact with each corresponding track.

In a non-represented variant, the terminals may be in the form of blades made of spring metal pressing against the corresponding tracks, so as to ensure electrical contact with said tracks.

In particular, the tracks extend:
either, in the represented embodiment, according to two parallel angular sectors—which extend over 360° in the represented embodiment —, the terminals being disposed at radial dimensions—with respect to the screwing axis 15—corresponding to those of each of said sectors,
or, in a non-represented embodiment, according to two angular sectors disposed in the extension of one another, said terminals being disposed according to two different angular positions and according to the radial dimension of said sectors.

According to the represented embodiment, the transducer 11—respectively or the ring 6 in a non-represented variant—is provided with a circular rack cooperating with a lug 17 projecting from the ring 6 —respectively or the transducer 11 in the non-represented variant —, said lug being arranged so that screwing of the attachment portion 12 requires a threshold force for said lug to pass from one notch 18 to another of said rack, in order to prevent inadvertent unscrewing of said transducer.

According to a partially represented embodiment, the panel 1 further comprises two cables 21 for connection to an amplifier, said cables being connected to the connectors 8, said panel further comprising a trench for the passage of said cables formed in the core 2.

1. A motor vehicle inner trim panel, said panel comprising a moulded core, said panel further comprising:
a base overmolded by said core in an fixing zone, said base being provided with a harpoon projecting from said core,
a ring provided with receiving means interlocking with said harpoon, so as to associate said ring with said base, said ring being further provided with two electric connectors configured to be connected to the outputs of an amplifier, the central opening of said ring being provided with a thread,
an electrodynamic or magnetostrictive transducer which is provided with an attachment portion in the general form of a threaded cylinder screwed into said opening, the free end of said attachment portion bearing in said zone so as to create a separation force between said ring and said base ensuring gripping contact between said harpoon and said receiving means, said transducer being further provided with two reciprocal electric connectors on which each of said connectors bears respectively.

2. The panel according to claim 1, the core being based on rigid or semi-rigid polyurethane foam.

3. The panel according to claim 1, the free end being inscribed in a plane bearing in the fixing zone lying in the same plane, so as to ensure surface contact between the two to optimise optimize the transmission of the signal derived from the amplifier.

4. The panel according to claim 1, the connectors—respectively or the reciprocal connectors—being in the form of terminals and the reciprocal connectors—respectively or the connectors—in the form of concentric tracks.

5. The panel according to claim 4, the terminals are in the form of studs mounted on a spring, so as to ensure electrical contact with each corresponding track.

6. The panel according to claim 4, characterized in that the terminals are in the form of blades made of spring metal pressing against the corresponding tracks, so as to ensure electrical contact with said tracks.

7. The panel according to claim 1, wherein the tracks extend:
either according to two parallel angular sectors, the terminals being disposed at radial dimensions corresponding to those of each of said sectors,
or according to two angular sectors disposed in the extension of one another, said terminals being disposed according to two different angular positions and according to the radial dimension of said sectors.

8. The panel according to claim 1, the transducer—respectively or the ring—being provided with a circular rack cooperating with a lug projecting from the ring —respectively or the transducer —, said lug being arranged so that screwing of the attachment portion requires a threshold force for said lug to pass from one notch to another of said rack, in order to prevent inadvertent unscrewing of said transducer.

9. The panel according to claim 1, further comprising two cables for connection to an amplifier, said cables being connected to the connectors, said panel further comprising a trench for the passage of said cables formed in the core.
